(19) United States
(12) Patent Application Publication
(10) Pub. No.: US 2001/0022957 A1
(43) Pub. Date: Sep. 20, 2001

(54) Purification of hydrogen fluoride

(76) Inventors: Somanahalli Naranappa Subbanna, East Amherst, NY (US); Charles Lewis Redmon, Orchard Park, NY (US); Robert Andrew Smith, Kinnelon, NJ (US); Paul Frederick Kunkel, Cheektowaga, NY (US)

Correspondence Address: COLLEEN D. SZUCH, Honeywell International Inc., 101 Columbia Road, Morristown, NJ, 07962-2245, US

(21) Appl. No.: 09/740,136

(22) Filed: Dec. 19, 2000

Related U.S. Application Data
(63) Continuation-in-part of application No. 09/476,307, filed on Dec. 30, 1999.

(51) Int. Cl. C01B 7/19; B01D 53/02

(52) U.S. Cl. 423/484; 423/210; 95/135; 95/116; 203/41

(57) ABSTRACT

A process for purifying anhydrous HF by contacting anhydrous HF containing phosphate impurities with an effective amount of activated carbon so that the phosphate impurities are adsorbed on the activated carbon, and anhydrous hydrogen fluoride having a reduced phosphate impurity content is obtained.

### CROSS REFERENCE TO RELATED APPLICATIONS

This application is a continuation-in-part of co-pending U.S. application Ser. No. 09/476307, which was filed on Dec. 30, 1999 and which is incorporated herein by reference.

### FIELD OF THE INVENTION

This invention relates to methods of obtaining high purity hydrogen fluoride (HF). In particular, the invention relates to a HF purification process that is capable of producing HF with exceptionally low levels of deleterious impurities, including phosphates and fluorophosphates.

### BACKGROUND OF THE INVENTION

The manufacture of HF, and particularly anhydrous HF, in commercial quantities typically consists of heating a mixture of fluorspar and sulfuric acid, which produces a gaseous crude product rich in HF. Fluorspar includes numerous impurities, including arsenic compounds, boron compounds, iron compounds, phosphorus compounds (hereinafter, “phosphates”), silicon compounds and sulfur compounds. Many of these impurities are converted to a gas when heated and are thus present in the crude product. U.S. Pat. No. 4,292,289, which is incorporated herein by reference, discloses a method of producing HF by reacting a fluoride bearing ore, such a fluorospar ore, with fluorosulfonic acid.

According to U.S. Pat. No. 3,167,391, which is incorporated herein by reference, certain undesirable phosphorous species can be converted to high boiling species to facilitate the removal of phosphates from the HF by fractional distillation. However, this process requires that water be added in an amount comprising about 10-18% of the product. The use of such a process is obviously undesirable for the production of anhydrous HF. Moreover, since fractional distillation is not particularly effective in removing phosphate impurities from such crude HF streams, certain amounts of undesirable high boiling phosphorous species may remain in the final HF product.

In order to maximize removal of phosphates using distillation, practitioners have heretofore frequently resorted to multiple stages of distillation and/or high pressure distillation, each of which requires substantial capital investment and results in a process with undesirably high operating costs. See, for example, U.S. Pat. No. 3,687,622, which is incorporated herein by reference.

Other methods for removing phosphates have also been disclosed. For example, U.S. Pat. No. 3,166,379 discloses a method for removing phosphates by adding chlorine, bromine or iodine, followed by distillation of the hydrogen fluoride. This process has the disadvantage of adding a new impurity, namely chlorine, to the anhydrous HF.

U.S. Pat. Nos. 4,668,497 and 5,362,469 disclose methods for removing phosphates by a process that involves adding an oxidizing agent, typically elemental fluorine, to the crude HF stream, followed by distillation of the modified hydrogen fluoride stream. Such processes are disadvantageous, however, in that they involve the need to handle quantities of elemental fluorine. The distillation procedures also present the same disadvantages described above in connection with U.S. Pat. No. 3,687,622. Moreover the oxidation processes have the added disadvantage that, depending on the oxidant added, a reducing agent may be required to destroy the excess oxidant, thus exposing the anhydrous HF to yet further contamination.

The present inventors have come to appreciate a need in the art for an improved process for the preparation of HF, and preferably anhydrous HF, with decreased levels of impurities. One particular object of the invention is a purification process which eliminates the need for extensive distillation to remove phosphate impurities from crude HF. Another object is to provide a process which eliminates the need for oxidants. Yet another object is to provide a process which is economically effective for use with relatively small quantities of HF, such as might be used by customers with smaller needs. Still yet another object is to provide a process that, because of the efficiency and effectiveness of its purification steps, permits the use of less expensive, higher phosphate content fluorspar raw material in processes for the manufacture of HF, and particularly anhydrous HF. These and other objects are achieved by the present invention.

### DETAILED DESCRIPTION OF THE INVENTION

The present inventors have discovered a process for removing impurities, preferably phosphate impurities, from a HF-containing stream by contacting the stream with an adsorbent, preferably an adsorbent which comprises activated carbon. We have discovered that adsorbtion, especially when combined with other separation techniques, is capable of producing an HF product with an impurity level, and particularly a phosphate impurity level, that would be extremely costly and difficult, if not impossible, to achieve using prior art processes. It is also believed that the present process is adaptable for removal of sulfur compounds, such as sulfur dioxide. Silicon compounds, such as silicon tetraflouride, are also potentially removed by the present process.

The present invention thus comprises the step of purifying crude HF by adsorbtion to produce purified HF. As used herein, the term “crude HF” refers to an HF-containing material that has a greater concentration of a particular impurity than a predetermined maximum amount of that impurity as determined by the application and intended use of the HF stream in each given industry. Those skilled in the art will appreciate that the predetermined maximum amount of a given impurity will vary widely depending on numerous factors, including the impurity involved and the expected use of the material after purification. It is expected that all such crude HF streams can be processed according to the present invention.

According to preferred embodiments, the crude HF to be processed contains greater than the predetermined maximum concentration of phosphate impurities. As mentioned above, the predetermined maximum amount of phosphate impurities will depend on the particular use contemplated for the purified HF stream. For example, the electronics industry (etching silicon wafers and cleaning silicon etching stations), glass industry (etching TV picture tubes) and nuclear industry (uranium hexafluoride for fuel rods) require very low levels of impurities. Some applications in the electronics industry currently prefer HF with 0.5 ppm, or less, of phosphate impurity, while other applications prefer levels of 0.1 ppm (100 ppb) or less of phosphates. Unless otherwise indicated, all percentages, ppms and ppbs used herein are on weight basis.

These low impurity requirements will become even more demanding as smaller and more complex chips are developed and produced. The current high purity anhydrous HF, for non-electronics industry use, has a typical specification of 5 ppm phosphate as determined by an industry accepted analysis methods. In general, therefore, the predetermined maximum phosphate concentration is preferably less than about 10 ppm. It is contemplated, however, that the present invention can be frequently utilized to its best advantage for embodiments in which the predetermined maximum phosphate concentration is less than about 1 ppm, and even more preferably less than about 0.1 ppm (100 ppb). As will be appreciated, such extremely low levels of phosphate impurities were not economically obtainable with prior art processes in large scale production. On the other hand, the present inventors believe that the present invention may also be used to great advantage in the production of streams with higher allowable phosphate concentrations, for example as high as 1000 ppm. In such embodiments, it is contemplated that the present invention will permit the purification of such materials at extremely high rates and/or at relatively low costs in comparison to many prior processes.

As used herein, the concentration of impurities in an HF stream refers to the amount of the impurity on a diluent free basis. As will be appreciated by those skilled in the art, HF is generally available without diluent or in combination with a diluent, usually water. As used herein, the term “anhydrous HF” refers to an HF-containing stream that contains less than about 0.05 weight percent water.

For purposes of the present invention, the term “phosphate” is intended to include all phosphate containing compounds, particularly those that are produced as a result of the HF production processes described herein. Without being bound by or to any particular theory, it is believed that at the levels of impurity experienced with the production of anhydrous HF from fluorspar, the actual phosphate species in the crude HF include an equilibrium combination of phosphoric acid, monofluorophosphoric acid, difluorophosphoric acid, phosphorous oxyfluoride, phosphorus pentafluoride, and hexafluorophosphoric acid. For purposes of the present invention, the presence of one or more of these compounds, or any other phosphate compound, is considered to be a phosphate impurity in the crude HF.

The first step according to preferred embodiments of the present invention is to provide crude HF, and preferably crude HF in substantially anhydrous form. In certain applications, the step of providing crude HF comprises simply obtaining from commercially available sources crude HF in the amount and at the rate required for the desired purpose. HF at various levels of purification are commercially available from Honeywell International, the assignee of the present invention. Alternatively, the crude HF may be provided directly to the present purification process as part of an integrated HF production facility. Present HF manufacturing processes typically produce crude HF streams containing varying levels of phosphate impurity. Streams containing from about 10 ppm to about 2,000 ppm phosphate are common and are suitable for purification in accordance with the present invention. Higher levels of phosphate impurities, for example 4000 ppm phosphate and higher, may also be purified.

The crude HF stream to be processed in accordance with the present invention can be a gas phase stream, a liquid phase stream, or a combination of liquid and gas phases. The vapor pressure of HF at various temperatures is well known an will determine the phase of the HF being processed. For example, at atmospheric pressure (760 mm Hg) HF has boiling point of 19.7° C. Thus, according to one embodiment of the present invention, the HF is maintained at about atmospheric pressure and a temperature of below about 19.7° C., thus resulting a liquid phase operation. HF in the liquid phase may also be achieved by operation at ambient temperature conditions but a pressure sufficiently elevated above atmospheric pressure to result in liquid phase HF. It is also contemplated that certain liquid phase embodiments may be conducted by utilizing a diluent for HF. However, at the present time, it is contemplated that such embodiments are generally not preferred because of potential problems that may arise because of adsorbtion competition with the diluent, which may result in reduced impurity removal.

The step of purifying the crude HF preferably comprises removing impurities, and preferably phosphate impurities, from the stream by adsorbing the impurities on an adsorbent. It is contemplated that, in view of teachings and disclosure contained herein, those skilled in the art will be able to select adsorbents that are effective in any particular application without undue experimentation. In general, it is contemplated that adsorbent materials may be selected from group of calcium sulfate adsorbents, carbon molecular sieves, and carbon. Carbon is generally preferred, with activated carbon being particularly preferred. For purposes of the present invention, the term “activated carbon” is given its commonly understood meaning to those of ordinary skill in the art. In general, activated carbon is understood to be a relatively complex, twisted network of defective carbon layer planes, cross linked by aliphatic bridging groups, and as described in U.S. Pat. No. 5,726,118—Ivy, et al. and U.S. Pat. No. 4,950,464, each of which is incorporated herein by reference. One of the most important physical characteristics of activated carbon is that it possesses an internal pore structure having a vast internal surface area. In general, commercially available forms of activated carbon have pore areas in the range of 500-2000 m²/g with some pore areas being reported as high as 3500-5000 m²/g.

In general, it is contemplated that activated carbon having pore sizes in the ranges indicated above will be adaptable for use in accordance with the present invention.

Activated carbon is a known product and the details of its manufacture are well known. In general, the process of forming activated carbon involves reacting free radicals on the carbon surface with molecules such as nitrogen and oxygen, resulting in the formation of functional groups when the carbon is being activated. These functional groups cause the surface of the activated carbon to become chemically reactive, which influences the absorptive properties of the activated carbon. As a result, the surface characteristics of the activated carbon can be amphoteric, that is either acidic or basic due to the formation of carboxylic groups, hydroxyl groups or carbonyl groups. It is believed that the presence of any or all of these functional groups may be included in the activated carbon of the present invention.

The production of activated carbon generally consists of two steps: carbonizing or charring, followed by activation of the carbon. Carbonizing, in general, involves subjecting the starting material to temperatures in the range of about 500 to about 700° C. Materials rich in carbon are typically employed for the manufacture of commercially available activated carbon and include coal, such as bituminous and sub-bituminous coals, as well as lignite, wood, nutshells, peat, pitches, cokes, such as coal-based coke or petroleum-based coke, wood chips, sawdust, coconut shells, petroleum fractions, and the like. Recent literature indicates that other carbon rich materials can be utilized in the formation of activated carbon, including automobile tires, water lilies, spent coffee grounds, waste plastics, straw, corn cobs, sewage sludge and other solid wastes. In the carbonizing step, the material is subject to the temperatures mentioned above in the substantial absence of oxygen. The carbonizing process is generally carried out in vertical or horizontal rotating kilns. Following carbonization, the material is activated by any one of well-known activation methods, including simple thermal treatment with an oxidizing gas, such as carbon dioxide, steam or a combination of these, at temperature of from about 750 to about 1,000° C.

As an alternative, chemical activation employs processing aids, such as phosphoric acid, sulfuric acid, hydrochloric acid or zinc chloride, which are added to the starting material, followed by heating to temperature of about 500° C. The carbonization step produces a carbon skeleton possessing a latent pore structure and in the activating step, the oxidizing atmosphere greatly increases the pore volume and surface area through elimination of volatile pyrolysis products.

Adsorbing activated carbon available for use in accordance with the present invention generally has pore diameters ranging from about 30 Angstroms to about 4,000 Angstroms. For embodiments of the present invention in which gas and vapor phase adsorbtion is to be employed, activated carbon having a significant volume of pores with diameters of less than about 30 Angstroms is preferred, whereas embodiments involving liquid phase separations it may have a significant number (eg., 20%) of pores with diameters of greater than about 300 and up to about 4,000 Angstroms.

Activated carbon is generally available in granular, pelletized and powdered form, with granular being preferred.

The activated carbon may be virgin or regenerated, with regenerated carbon being preferred as such carbon is less expensive. The preferred form of activated carbon has been acid washed so as to reduce, and preferably substantially eliminate, the introduction into the HF stream of contaminants from the carbon itself.

The activated carbon of the present invention is preferably in particulate form. The particle size distribution that is selected will depend on the desired contact time and pressure drop through the activated carbon bed, and those skilled in the art will be able to make these selections for any particular set of requirements. The activated carbon preferably has a particle size of about 4×8-30×140 mesh, with 12×30-12×40 mesh being most preferred for lab scale work. Activated carbon suitable for use in accordance with the present invention is available commercially from numerous sources. According to certain embodiments, the activated carbon is a coconut-based activated carbon sold by Calgon Carbon Corporation under the trade designation “PCB”. Acceptable activated carbon products are also available from Norit Americas, Inc.

The adsorbtion step of the present invention includes both continuous and batch processes, with the continuous processing being preferred. In either case, the adsorbtion step is preferably carried out at temperatures of from about 20° C. to about 75° C. and at pressures of from about atmospheric to about 50 psig.

In the preferred continuous processes, crude HF, in the vapor phase, the liquid phase, or in a stream containing both liquid and vapor phases, is preferably passed over or through an adsorbent material, preferably comprising activated carbon, with the adsorbant being present in an amount sufficient and arranged in a manner effective to remove the impurity to below the predetermined maximum amount. In general it preferred that the adsorbent is included in an arrangement that includes a bed of adsorbent. It is contemplated that the bed of adsorbent in such embodiments may be substantially static, such as in a fixed bed, or dynamic, such as in a fluidized bed, or may involve both types of beds in combination.

The flow rate at which the crude HF is passed through the adsorbent bed or beds can be readily determined by those skilled in the art based on the size and type of adsorbent being used, which in turn is based on the other particular process and product requirements. Therefore, the type and amount of adsorbent to be employed, and the amount of adsorbent to use, with a given process can be readily determined by one skilled in the art without undue experimentation. In general larger quantities of adsorbent increase the amount of time necessary for regeneration of the bed. The flow rate used will also depend on the desired purity level. Higher purity levels require lower flow rates to increase the residence time of the anhydrous HF on the adsorbent to ensure thorough adsorption of phosphate impurities.

For embodiments in which a substantially static bed of activated carbon is used, the flow rate of HF gas to the bed is from about 20 to about 400 cc (HF gas)/min. per cc of activated carbon bed). According to other preferred embodiments, the flow rate of liquid phase HF to the bed is from about 0.05 to about 0.1 cc (liquid HF/min. per cc of activated carbon bed).

As the process continues, the impurities build up in the adsorbent material, particularly the activated carbon bed. Eventually the bed begins to become saturated with the impurities. When this occurs, the level of phosphates in the finished product begins to increase, at which time the activated carbon is either replaced or, preferably, regenerated.

Replacement and/or regeneration are preferably performed before occurrence of a “breakthrough” in the phosphate impurity level for embodiments involving a single activated carbon bed or a parallel bed arrangement. For embodiments in which two or more beds are used in a series arrangement, it is contemplated that the level of impurity at the exit of the first bed could well exceed the “breakthrough” level since the one or more subsequent bed(s) in the series would act as buffer zones to ensure that the partially purified HF leaving the first bed is purified to the desired impurity level. In such embodiments, the first bed is generally taken off-line and a newly regenerated bed would be introduced to the series arrangement. In general, a “breakthrough” is deemed to have occurred when the level of the impurity in the purified stream leaving the adsorbtion step exceeds the predefined maximum amount of impurity for the desired product. For example, when a product has a predetermined maximum impurity of 10 ppm phosphate, then the breakthrough concentration is set at 10 ppm. When a product with less than 1 ppm phosphate impurity is desired, then the breakthrough concentration is set at 1 ppm, and so forth.

The activated carbon is regenerated by well-understood, conventional means such as, for example, those disclosed in Japanese Patent No. JP 10151344 (date Jun. 9, 1998) and “Effects of Water Residues on Solvent Adsorption Cycles,” Schweiger, Thomas A. J., Ind. Eng. Chem. Res. (1995), 34(1), 283-7, each of which is incorporated herein by reference. For example, the activated carbon may be washed with water or dilute aqueous potassium hydroxide to leach out the collected impurities, rinsed with water as needed to remove potassium hydroxide (as needed) and then re-used. The activated carbon is preferably dried before reuse. The potassium hydroxide solution may be re-used until it contains a phosphate concentration that interferes with the regeneration process, which is readily identified by those skilled in the art, at which point the phosphate compounds are preferably disposed of in a commercially and environmentally acceptable manner. In such a process the crude HF flow is alternated between two carbon beds, with one carbon bed being regenerated while the other is employed for purification.

The present invention may also be performed as part of a process in which purified HF, either in diluted or undiluted form, is added to a chemical reaction, preferably as part of a commercial process. That is, an in-line purification process may be provided as part of a step to supply high purity anhydrous or dilute aqueous HF to a chemical reaction. However, when it is desired to supply dilute aqueous HF to a chemical reaction, the dilution step preferably is performed after the purification process.

In a preferred embodiment, the present methods further comprise the step of separating impurities from a crude HF stream by distillation, which can occur before and/or after the adsorption step. It is generally preferred, however, that the present process include a distillation step in advance of the adsorption step. In this way, a relatively large amount of impurities can be removed from the crude HF before exposure to the adsorption process. This is considered advantageous because it tends to increase the cycle times for bed regeneration and also because it helps avoid contaminating the activated carbon with other impurities that are more easily removed by distillation. The adsorption step is therefore preferably positioned in the process so as to more economically and efficiently achieve very low impurity levels.

It is contemplated that the present purification steps are adaptable for use with crude HF streams containing as much as 10% by weight of water as a diluent. However, high levels of water are generally not preferred since the water tends to carry the impurities out of the carbon bed and into the purified stream. The concentration of water in the crude of HF stream is thus more preferably not greater than about 5% by weight, and according to certain preferred embodiments the crude HF is substantially anhydrous HF. HF may thus be produced in accordance with the present invention having a purity (on a diluent-free basis) of greater than 99.99% by weight. The purified HF product may be distributed in the anhydrous state, or it may be diluted with pure water to concentrations desired by industry. At present, products containing HF concentrations in water of 38%, 49% and 70% of HF in water are commercially available. It is also common in HF manufacturing to use HF streams containing approximately 1-10% by weight of HF.

The present invention allows HF plants to meet the ever decreasing specification limits set by customers and allows for increased capacity at industrial plants.

The following examples illustrate a preferred process by which phosphate impurities are removed from anhydrous HF but do not in any way restrict the effective scope of the invention.

### EXAMPLES

Each of the examples which follow is based on purification of a crude HF stream. The crude HF is first distilled to remove non-phosphate impurities, and then fed to an activated carbon adsorption bed. The activated carbon used in the bed is acid washed, 12×30 mesh, PCB grade from Calgon Corp. HF flow through the bed is regulated with a rotometer and temperatures are measured with thermocouples. The effluent from the adsorption step is then analyzed to determine phosphate content. Analysis of phosphates content is performed by carefully volatilizing the HF and converting any fluorophosphate species to orthophosphate. Orthophosphate is determined by the standard molybdenum blue colorimetric methods. More particularly, the anhydrous HF is adsorbed onto frozen distilled water, iced to about 20% concentration using two scrubbers in series. Both scrubbers are analyzed for phosphate content. The molybdenum blue method used for analysis comprises adding concentrated nitric acid to an appropriate size sample and liquid thereof evaporated on a steam bath. The evaporation removes the HF and allowed hydrolysis of the fluorophosphate species to orthophosphate. Ammonium molybdate is added to the orthophosphate and a yellow color is developed. This yellow color can be enhanced (for samples with low phosphate content) by adding the sodium salt of 1-amino-2-napthal-4-sulphonic acid and a reducing agent, such as sodium bisulfate and sodium metabisulfate, to convert the yellow material to a more intense blue color. Either color can be determined spectrophotometrically by comparison to known standards.

### Example 1

Anhydrous HF containing 10 ppm phosphates at atmospheric pressure and 70° C. is introduced into the activated carbon bed at a rate of about 1500 cc/min. The activated carbon bed comprises the aforementioned Calgon™ PCB granules contained in a cylindrical bed of a diameter of about ¼ and a length of about 6 inches using a stainless steel tube. No distributer is used, the pressure is atmospheric, and the outlet temperature is 70° C. The resulting anhydrous HF contained 0.1 ppm phosphates.

### Example 2

Anhydrous HF containing 320 ppm phosphates at atmospheric pressure and 70° C. is introduced into the activated carbon bed at a rate of about 500 cc/min. The activated carbon bed comprises the aforementioned Calgon™ PCB granules contained in a cylindrical bed about ½ in diameter and 6 inches long using a stainless steel tube. No distributer is used, the pressure is atmospheric, and the outlet temperature is 70° C. Breakthrough (approximately 10 ppm phosphates in the purified HF) is noted after 480 grams of HF pass through the bed.

### Example 3

Anhydrous HF containing 2000 ppm phosphates is passed through a carbon bed as in Example 2. Breakthrough (approximately 10 ppm phosphates in the purified HF) is noted after 360 grams of HF pass through the bed.

### Example 4

Anhydrous HF in a liquid phase stream containing 2000 ppm phosphates is introduced at from about 5 to 75 psig and about ambient temperature into the activated carbon bed of Example 1 at a rate of about 1 gram/min. Anhydrous HF liquid exiting the bed is vaporized and then absorbed in water scrubbers and is found to contain less than about 0.35 ppm phosphates. Breakthrough (approximately 10 ppm phosphates in the purified HF) does not occur even after 13.8 kilograms of anhydrous HF is passed through the carbon bed.

The present invention thus provides a convenient means by which the phosphorous content of anhydrous HF can be reduced to commercially-acceptable levels.

The above description and examples are meant to assist in illustrating the principles of the invention. It should be noted that the following claims are not to be so limited and should be afforded the scope commensurate with the wording of each element of the claim and the equivalents thereof.

1. A process for removing from crude hydrogen fluoride at least one impurity, said process comprising adsorbing said at least one impurity onto an adsorbent to produce purified hydrogen fluoride containing less of said impurity than said crude hydrogen fluoride.

2. The process of claim 1 wherein said crude hydrogen fluoride contains no greater than about 10% by weight of water.

3. The process of claim 1 wherein said crude hydrogen fluoride contains no greater than about 5% by weight of water.

4. The process of claim 1 wherein said crude hydrogen fluoride is crude anhydrous hydrogen fluoride.

5. The process of claim 1 wherein said crude hydrogen fluoride comprises a vapor phase stream containing hydrogen fluoride.

6. The process of claim 1 wherein said crude hydrogen fluoride comprises a liquid phase stream containing hydrogen fluoride.

7. The process of claim 2 wherein said at least one impurity is selected from the group consisting of phosphates, sulfur compounds, silicon compounds, and mixtures of two or more of these.

8. The process of claim 2 wherein said at least one impurity comprises a phosphate impurity.

9. The process of claim 8 wherein said adsorbent comprises activated carbon in an amount effective and under conditions sufficient to ensure that said purified hydrogen fluoride contains no more than about 10 ppm of said phosphate.

10. The process of claim 9 wherein said purified hydrogen fluoride contains no more than about 5 ppm of said phosphate.

11. The process of claim 9 wherein said purified hydrogen fluoride contains no more than about 1 ppm of said phosphate.

12. The process of claim 1 wherein said adsorption step comprises a batch process.

13. The process of claim 1 wherein said adsorption step comprises a continuous process.

14. The process of claim 9 wherein said phosphate impurity is reduced to less than about 1 ppm.

15. The process of claim 1 wherein said crude hydrogen fluoride is distilled to remove impurities prior to said adsorption step.

16. A process for purifying crude anhydrous hydrogen fluoride containing phosphate and other impurities, said process comprising the steps of distilling said crude anhydrous hydrogen fluoride to remove at least a portion of said other impurities and contacting the distilled anhydrous hydrogen fluoride with activated carbon under conditions effective to produce purified anhydrous hydrogen fluoride having a phosphate impurity content less than about 5 ppm.

17. The process of claim 16 wherein said contacting step comprises a batch process in which a predetermined quantity of said anhydrous hydrogen fluoride is contacted with said activated carbon.

18. The process of claim 16 wherein said contacting step comprises a continuous process in which a flow of anhydrous hydrogen fluoride is passed through said activated carbon.

19. The process of claim 16 further comprising distilling said purified hydrogen fluoride to remove impurities after said adsorption step.

20. A process for purifying crude anhydrous hydrogen fluoride containing greater than a predetermined amount of at least one impurity, said process comprising adsorbing a sufficient quantity of said at least one impurity onto activated carbon to produce purified hydrogen fluoride containing less than about said predetermined maximum amount of said at least one impurity.

21. The process of claim 20 wherein said crude anhydrous hydrogen fluoride comprises vapor phase hydrogen fluoride.

22. The process of claim 20 wherein said crude anhydrous hydrogen fluoride comprises liquid phase hydrogen fluoride.

23. The process of claim 20 wherein said at least one impurity is selected from the group consisting of phosphates, sulfur compounds, silicon compounds, and mixtures of two or more of these.

24. A process for producing a purified anhydrous hydrogen fluoride stream comprising less than about 0.1 ppm phosphate impurity from a crude anhydrous hydrogen fluoride stream containing greater than about 10 ppm of phosphate impurity and at least one other impurity, said process comprising:
a) distilling said crude anhydrous hydrogen fluoride to remove at least a portion of said other impurity, and optionally a portion of said phosphate impurity, to produce a partially purified hydrogen fluoride stream comprising greater than about 0.1 ppm of phosphate impurity; and
b) removing a sufficient quantity of said phosphate impurity from said partially purified hydrogen fluoride stream to produce a purified hydrogen fluoride steam containing less than about 0.1 ppm of phosphate impurity, said removing step comprising substantially continuously contacting said partially purified hydrogen fluoride stream with a fixed bed of activated carbon in particulate form.

25. The process of claim 24 wherein said contacting step comprises introducing a partially purified HF stream in the vapor phase to a fixed bed of activated carbon having a particle size of from about 4×8 mesh to about 10×140 at a flow rate of from about 20 to about 400 cc gas/min./cc of activated carbon, said bed being maintained at a temperature of from about 20° C. to about 75° C. and a pressure of less than about 50 psig.

26. The process of claim 24 wherein said contacting step comprises introducing a partially purified HF stream in the liquid phase to a fixed bed of activated carbon having a particle size of from about 4×8 mesh to about 10×140 at a flow rate of from about 0.05 to about 0.1 cc liquid/min./cc of activated carbon, said bed being maintained at a temperature of from about 20° C. to about 75° C. and a pressure of less than about 50 psig.
